(19) United States
(12) Patent Application Publication
(10) Pub. No.: US 2025/0091022 A1
(43) Pub. Date: Mar. 20, 2025

(54) COATING SLURRY SUPPLY DEVICE

(71) Applicants: Hyundai Motor Company, Seoul (KR); Kia Corporation, Seoul (KR)

(72) Inventors: Shin Kook Kong, Suwon (KR); Jin Su Yoon, Hwaseong (KR); Hee Soo Jeong, Seoul (KR)

(21) Appl. No.: 18/608,180

(22) Filed: Mar. 18, 2024

(30) Foreign Application Priority Data
Sep. 18, 2023 (KR) 10-2023-0124133

(51) Int. Cl. B01F 31/85; B01F 27/05; B01F 35/90; B01J 19/10

(52) U.S. Cl. CPC B01F 31/85; B01F 27/05; B01F 35/90; B01J 19/10; B01F 2035/98

(57) ABSTRACT

Disclosed is a coating slurry supply device including an ultrasonic generator and a stirrer installed in a pipe configured to allow a slurry to be transferred therethrough. While the slurry is transferred through the pipe, a slurry additive containing a conductive material is dispersed and stirred. While being transferred through the pipe, the slurry does not stagnate in a specific section, thereby preventing slurry agglomeration caused by long-term mixing or dispersion. The slurry, the temperature of which increases due to heat generated during mixing or dispersion, is cooled through a cooling jacket, thereby appropriately adjusting the temperature so as to coat the slurry on a current collector or a support. This structure minimizes a change in physical properties of the slurry and maximizes dispersion of the slurry additive containing the conductive material.

### CROSS-REFERENCE TO THE RELATED APPLICATION

This application claims under 35 U.S.C. § 119 (a) the benefit of Korean Patent Application No. 10-2023-0124133, filed on Sep. 18, 2023, in the Korean Intellectual Property Office, the disclosure of which is incorporated herein by reference in its entirety.

### BACKGROUND

### Technical Field

The present disclosure relates to a coating slurry supply device capable of minimizing a change in physical properties of a slurry and maximizing dispersion of an additive containing a conductive material.

### Background

In general, a lithium secondary battery includes a positive electrode obtained by forming a positive electrode active material layer on at least one side of a positive electrode current collector, a negative electrode obtained by forming a negative electrode active material layer on at least one side of a negative electrode current collector, and a separator interposed between the positive electrode and the negative electrode and configured to electrically insulate the positive electrode and the negative electrode.

As a method of forming an electrode (a positive electrode or a negative electrode) active material layer on a current collector, first, an electrode active material particle, an additive containing a conductive agent, and a binder resin are dispersed in a solvent to be mixed with each other therein, and the mixture is stirred to generate an active material slurry. Next, the generated active material slurry is applied to both sides of the current collector, and both sides are dried and roll pressed. Thereafter, an electrode active material slurry is directly applied to the current collector and dried thereon, or the electrode active material slurry is applied to an upper portion of a separate support and dried thereon. Then, a film peeled from this support is coated on the current collector, thereby forming the electrode active material layer on the current collector.

In this case, ionic conductivity is significantly affected by a degree of dispersion of the additive containing the conductive agent. Therefore, the ionic conductivity of the formed electrode active material layer is uniformly maintained only when the additive containing the conductive agent is evenly dispersed in the electrode active material slurry.

However, in the case of using a conventional dispersion method of simultaneously adding an electrode active material particle, a conductive agent, and a binder resin to a solvent and stirring and dispersing the same in a mixer, it is difficult to uniformly disperse a conductive agent particle in a slurry due to a difference in size and specific gravity between the electrode active material particle and the conductive agent particle.

Additionally, when a slurry is mixed or dispersed for a long time in a mixer container, a change in physical properties of the slurry occurs. For example, viscosity of the slurry rapidly increases and heat is generated. However, in order to coat the slurry on a current collector or a support, it is necessary to maintain viscosity and temperature of the slurry below a predetermined level.

The change in physical properties of the slurry due to mixing of the slurry makes it difficult to coat the slurry on the current collector or the support.

The information disclosed in this Background of the Disclosure section is only for enhancement of understanding of the general background of the disclosure, and should not be taken as an acknowledgement or any form of suggestion that this information forms the related art already known to a person skilled in the art.

### SUMMARY

Therefore, the present disclosure has been made in view of the above problems, and it is an object of the present disclosure to provide a coating slurry supply device configured to perform dispersion and stirring of a slurry additive containing a conductive material while a slurry is transferred through a pipe and to prevent the slurry from stagnating in a specific section, thereby making it possible not only to prevent slurry agglomeration caused by long-term mixing or dispersion, but also to minimize a change in physical properties of the slurry and maximize dispersion of the additive containing the conductive material.

It is another object of the present disclosure to provide a coating slurry supply device using a cooling jacket configured to cool a slurry, the temperature of which increases due to heat generated during mixing or dispersion, thereby making it possible to appropriately adjust the temperature so as to coat the slurry on a current collector or a support.

The objects of the present disclosure are not limited to the above-mentioned object, and other objects not yet mentioned will be clearly understood by those of ordinary skill in the art to which the present disclosure pertains from the following descriptions.

In accordance with the present disclosure, the above and other objects can be accomplished by the provision of a coating slurry supply device including a pipe configured to allow a slurry containing an additive to be transferred therethrough, a conveyance mechanism configured to provide conveyance force to the slurry flowing through the pipe, a stirrer installed in the pipe and configured to stir the slurry flowing through the pipe, and an ultrasonic generator installed in the pipe, wherein the ultrasonic generator is configured to disperse the additive contained in the slurry by applying ultrasonic waves to the slurry flowing through the pipe.

The ultrasonic generator may include a vibration unit configured to transmit vibration to the slurry flowing through the pipe to disperse the additive contained in the slurry, wherein the vibration unit may be completely inserted into the pipe.

The ultrasonic generator may include a driving unit configured to operate the vibration unit, wherein the driving unit may be disposed outside the pipe.

The pipe may be formed to extend with a constant inner diameter thereof, wherein the inner diameter may remain the same at a location where the stirrer and the ultrasonic generator are installed.

The stirrer may include a leg unit rotated in a state of being completely inserted into the pipe and configured to stir the slurry.

The leg unit of the stirrer may surround the vibration unit.

The leg unit may have an inner circumferential surface configured to surround the vibration unit in a state of being spaced apart from an outer circumferential surface of the vibration unit by a predetermined distance.

A separation distance between the outer circumferential surface of the vibration unit and the inner circumferential surface of the leg unit may be about 5 to about 100 mm.

The vibration unit or the leg unit may have a scraper provided on the outer circumferential surface thereof or the inner circumferential surface thereof, wherein the scraper may be configured to scrape the slurry remaining in a space defined between the outer circumferential surface of the vibration unit and the inner circumferential surface of the leg unit.

The pipe may be divided into an inlet pipe and an outlet pipe, wherein the inlet pipe and the outlet pipe may be connected to each other in a vertically offset state so as to partially overlap each other, and wherein the stirrer and the ultrasonic generator may be installed at a location where the inlet pipe and the outlet pipe are connected to each other.

The outlet pipe may be disposed above the inlet pipe.

The stirrer may include a leg unit rotated in a state of being completely inserted into the pipe and configured to stir the slurry, wherein the leg unit may be built across the inlet pipe and the outlet pipe, and wherein the leg unit may be connected to an actuator located outside the pipe through a rotation shaft.

The ultrasonic generator may be disposed on an inner side of the pipe located at the location where the inlet pipe and the outlet pipe are connected to each other.

The leg unit of the stirrer adjacent to the ultrasonic generator may have a scraper provided on an outer circumferential surface thereof, wherein the scraper may be configured to scrape the slurry remaining in a space defined between the ultrasonic generator and the outer circumferential surface of the leg unit.

The coating slurry supply device may further include a cooling jacket provided in the pipe and configured to reduce the temperature of the slurry flowing through the pipe.

The cooling jacket may be formed on an outer circumferential surface of the pipe and extends along the pipe.

The slurry flowing through the pipe may have a flow direction opposite a flow direction of a refrigerant flowing through the cooling jacket.

The coating slurry supply device may further include a controller configured to control ultrasonic intensity and frequency of the ultrasonic generator, and a sensor installed in the pipe and configured to sense information on the slurry, wherein the information may include a change in physical properties including residence time in the pipe of the slurry, temperature of the slurry, and viscosity of the slurry. The controller may be configured to control, based on the information including the residence time in the pipe, the temperature, and the viscosity of the slurry sensed by the sensor, the ultrasonic intensity and the frequency of the ultrasonic generator according to a predetermined criterion.

As discussed, the method and system suitably include use of a controller or processer.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a diagram showing an example of a slurry coating process;

FIG. 2 is a diagram showing an embodiment of a coating slurry supply device of the present disclosure;

FIG. 3 is a diagram showing another embodiment of the coating slurry supply device of the present disclosure; and

FIG. 4 is a diagram showing still another embodiment of the coating slurry supply device of the present disclosure.

### DETAILED DESCRIPTION OF THE PREFERRED EMBODIMENTS

Reference will now be made in detail to the preferred embodiments of the present disclosure, examples of which are illustrated in the accompanying drawings. Wherever possible, the same reference numbers will be used throughout the drawings to refer to the same or like parts, and redundant descriptions thereof will be omitted.

In describing the embodiments disclosed herein, when it is determined that the detailed description of publicly known techniques to which the disclosure pertains may obscure the gist of the present disclosure, the detailed description will be omitted. Further, it should be understood that the accompanying drawings are merely illustrated to easily describe the embodiments disclosed in this specification, and therefore, the technical idea disclosed in this specification is not limited by the accompanying drawings. Further, it should be noted that the accompanying drawings include all modifications, equivalents, and substitutes that fall within the spirit and technical scope of the present disclosure.

In this specification, an expression in a singular form also includes the plural sense, unless clearly specified otherwise in context.

It should be understood that expressions such as “comprise” and “have” in this specification are intended to designate the presence of indicated features, numbers, steps, operations, components, parts, or combinations thereof, but do not exclude the presence or addition of one or more features, numbers, steps, operations, components, parts, or combinations thereof.

Hereinafter, the suffixes “module”, “unit”, and “part” for components used in the following description are merely provided for facilitation of preparing this specification. Therefore, the suffixes themselves do not have significant meanings or roles.

When one component is referred to as being “connected” or “joined” to another component, the one component may be directly connected or joined to the other component, but it should be understood that other components may be present therebetween. On the other hand, when the one component is referred to as being “directly connected to” or “directly in contact with” the other component, it should be understood that no other components are present therebetween.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation, and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”. According to a coating slurry supply device of the present disclosure, an ultrasonic generator and a stirrer are installed in a pipe through which a slurry is transferred. Dispersion and stirring of a slurry additive containing a conductive material are performed while the slurry is transferred through the pipe. When the slurry is transferred through the pipe, the slurry does not stagnate in a specific section, thereby making it possible not only to prevent slurry agglomeration due to long-term mixing or dispersion, but also to minimize a change in physical properties of the slurry and maximize dispersion of the additive containing the conductive material. In addition, a cooling jacket is provided to cool the slurry, the temperature of which increases due to heat generated during mixing or dispersion, thereby making it possible to appropriately adjust the temperature so as to coat the slurry on a current collector or a support.

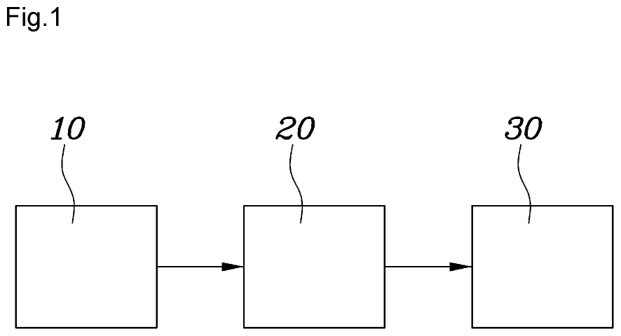

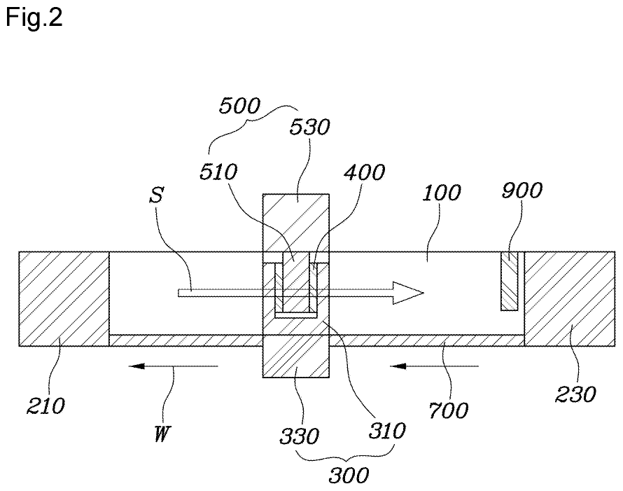

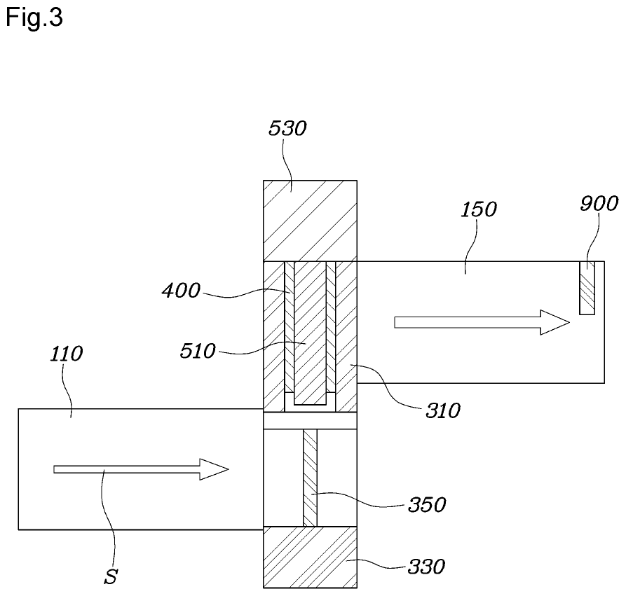

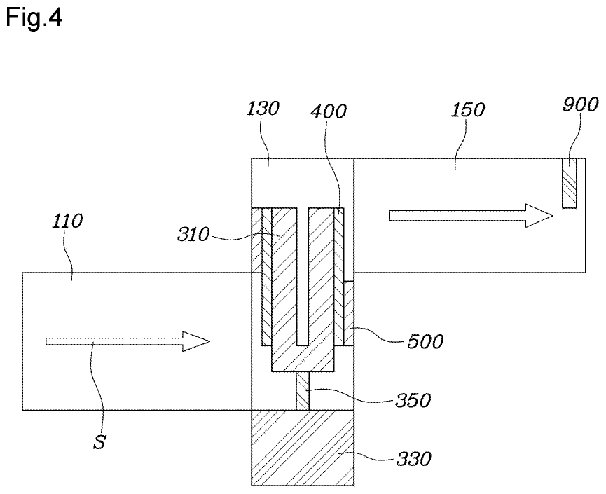

FIG. 1 is a diagram showing an example of a slurry coating process, FIG. 2 is a diagram showing an embodiment of a coating slurry supply device of the present disclosure, and FIG. 3 is a diagram showing another embodiment of the coating slurry supply device of the present disclosure, FIG. 4 is a diagram showing still another embodiment of the coating slurry supply device of the present disclosure.

FIG. 1 is a diagram showing the example of the slurry coating process. In FIG. 1, the slurry coating process will be described.

A slurry stored in a slurry tank 10 may be transferred to a slot die coater 30 through a slurry supply device 20, and a current collector or a support in the slot die coater 30 may be coated with the slurry. In this case, the slurry may be transferred from the slurry tank 10 to the slot die coater 30 through the slurry supply device 20, and simultaneously, mixing through stirring and dispersion through ultrasonic waves may be performed.

FIG. 2 is a diagram showing the embodiment of the coating slurry supply device of the present disclosure. The coating slurry supply device of the present disclosure will be described with reference to FIG. 2.

The coating slurry supply device of the present disclosure may include a pipe configured to allow a slurry containing an additive to be transferred therethrough, a conveyance mechanism configured to provide conveyance force to the slurry flowing through the pipe, a stirrer 300 installed in the pipe and configured to stir the slurry flowing through the pipe, and an ultrasonic generator 500 installed in the pipe and configured to disperse the additive contained in the slurry by applying ultrasonic waves to the slurry flowing through the pipe.

First, transfer S of the slurry may be performed by a slurry feeding pump 210, which is a transfer mechanism, and the slurry may be supplied into the pipe. That is, the slurry is transferred along the pipe. An additive containing a conductive material in the slurry may be dispersed while the slurry is transferred through the ultrasonic generator 500, and the slurry is stirred through the stirrer 300. Thereafter, a sensor 900 may sense physical properties of the slurry flowing through the pipe, such as viscosity and temperature of the slurry, and the slurry may be discharged to the outside of the pipe by a slurry supply pump 230, which is another transfer mechanism.

Ionic conductivity may be significantly affected by a degree of dispersion of the additive containing the conductive agent in the slurry. Therefore, ionic conductivity of a formed electrode active material layer may be uniformly maintained only when the additive containing the conductive agent is evenly dispersed in an electrode active material slurry. However, in the case of using a conventional dispersion method of simultaneously adding an electrode active material particle, an additive containing a conductive agent, and a binder resin to a solvent and stirring and dispersing the same in a mixer, it may be difficult to uniformly disperse a conductive agent particle in the slurry due to a difference in size and specific gravity between the electrode active material particle and the conductive agent particle.

To solve this problem, additional dispersion using ultrasonic waves may be performed after a stirring process. However, when a slurry is exposed to ultrasonic waves for a long time, viscosity of the slurry rapidly increases and heat is generated. Particularly, when an additive containing a conductive material in the slurry is dispersed using ultrasonic waves in a state in which the slurry is stored in a container, the slurry stagnant in the container is affected by ultrasonic waves for a long time. As a result, viscosity of the slurry sharply increases and heat is generated.

Meanwhile, a slurry may be coated on a current collector or a support when the same has viscosity of 500 to 20,000 cP. When a slurry has viscosity of 20,000 cP or more, the slurry deteriorates, which may cause slurry agglomeration and the like. Accordingly, it is difficult to coat the slurry on a current collector or a support.

Therefore, in the related art, ultrasonic dispersion is performed on a slurry having viscosity of 500 to 1,000 cP in a container. Meanwhile, after ultrasonic dispersion is performed on a slurry for a lithium secondary battery having viscosity of 5,000 to 10,000 cP in a container, viscosity of the slurry increases to 20,000 cP or more. Accordingly, it is not possible to perform ultrasonic dispersion.

However, in the case of the coating slurry supply device of the present disclosure, a slurry transferred through a pipe may keep flowing through the pipe without stagnating near the ultrasonic generator 500. Through this structure, an additive containing a conductive material in the slurry may undergo ultrasonic dispersion in a short time and, as such, the slurry may not be affected by ultrasonic waves for a long time. Accordingly, viscosity of the slurry may not increase rapidly.

As a result, while the additive containing the conductive material in the slurry may be effectively dispersed, an increase in viscosity of the slurry may be minimized. Further, at this time, slurry agglomeration may be effectively controlled so as not to exceed a predetermined level by allowing the stirrer 300 to stir and circulate the slurry. Through this process, the slurry may be reliably coated on the current collector or the support.

In addition, ultrasonic intensity and frequency may be preset in consideration of physical properties of the slurry such as slurry residence time in the pipe, temperature of the slurry after dispersion, and viscosity of the slurry, thereby making it possible to provide a slurry having physical properties such as viscosity and temperature required for coating.

That is, in the present disclosure, a slurry may flow through a pipe and may be simultaneously stirred in the pipe. Particularly, the slurry may be stirred in the pipe and is also dispersed by ultrasonic waves therein, thereby obtaining both necessary dispersion of the slurry and appropriate viscosity thereof.

Meanwhile, the pipe through which the slurry flows may have an extended shape with a constant inner diameter thereof. Further, the pipe may have the same inner diameter at a location where the stirrer 300 and the ultrasonic generator 500 are installed.

Through the above-described structure having a constant inner diameter of a pipe, the slurry may be reliably transferred through the pipe, and slurry stagnation may be effectively prevented. In this manner, it is possible to prevent slurry agglomeration that occurs when the slurry is exposed to ultrasonic waves for a long time.

Next, a vibration unit 510 of the ultrasonic generator 500 of the present disclosure is completely inserted into the pipe. The ultrasonic generator 500 transmits ultrasonic waves to the slurry through the vibration unit 510 completely inserted into the pipe.

When the vibration unit 510 is not completely inserted into the pipe but is partially inserted thereinto, the slurry may stagnate in a portion of the vibration unit 510, the portion being not inserted into the pipe, and the slurry may be affected by ultrasonic waves for a long time. As a result, viscosity of the slurry may increase and slurry agglomeration may occur.

However, when the vibration unit 510 of the ultrasonic generator 500 is completely inserted into the pipe as in the present disclosure, the slurry may be transferred through the pipe without stagnating in the vibration unit 510. Accordingly, the slurry may not be affected by ultrasonic waves for a long time, thereby preventing a rapid increase in viscosity of the slurry. Through this configuration, an additive containing a conductive material in the slurry may be evenly dispersed, thereby effectively preventing an increase in viscosity of the slurry and temperature thereof.

Meanwhile, the vibration unit 510 may have a rod shape or a bar shape. Through this shape, ultrasonic waves may be effectively transmitted to the slurry, and the slurry may be transferred in the pipe without interference, thereby preventing the slurry from stagnating around the vibration unit 510. In this manner, the slurry may be smoothly transferred while flowing through the pipe.

In addition, the ultrasonic generator 500 of the present disclosure may include a driving unit 530 configured to operate the vibration unit 510, and the driving unit 530 is provided outside the pipe. Through this structure, the vibration unit 510 of the ultrasonic generator 500 may be completely inserted into the pipe, and the slurry in the pipe may be completely transferred through the pipe without stagnating in the vibration unit 510 of the ultrasonic generator 500. Through this configuration, the slurry is not affected by ultrasonic waves for a long time, thereby preventing a rapid increase in viscosity and temperature of the slurry. Accordingly, an additive containing a conductive material in the slurry is effectively dispersed, and viscosity and temperature of the slurry are prevented from exceeding a predetermined level.

In addition, the stirrer 300 of the present disclosure may also need to be rotated in a state of being completely inserted into the pipe. To this end, the stirrer 300 includes a leg unit 310 configured to stir the slurry and completely inserted into the pipe. When the leg unit 310 is not completely inserted into the pipe but is only partially inserted thereinto, the slurry stagnates around a portion of the leg unit 310, the portion being not inserted into the pipe, and, as such, the slurry is affected by ultrasonic waves for a long time. As a result, viscosity of the slurry increases and agglomeration of the slurry occurs.

However, in the stirrer 300 of the present disclosure, since the leg unit 310 is completely inserted into the pipe, the slurry may be transferred through the pipe without stagnating in the leg unit 310. The slurry is not affected by ultrasonic waves for a long time, thereby preventing a rapid increase in viscosity of the slurry. Through this configuration, an increase in viscosity of the slurry may be effectively prevented.

Additionally, the leg unit 310 of the stirrer 300 of the present disclosure may surround the outside of the vibration unit 510. More specifically, a plurality of leg units 310 each having a bar shape or a rod shape are disposed spaced apart from each other, and the inner peripheral surfaces of the leg units 310 surround the vibration unit 510 in a state of being spaced apart from the outer peripheral surface of the vibration unit 510 by a predetermined distance.

The slurry may effectively approach the vibration unit 510 through spaces defined between the plurality of leg units 310 and spaced apart from each other, and an additive containing a conductive material in the slurry may be dispersed through ultrasonic waves. In addition, it is possible to effectively prevent the slurry from stagnating near the vibration unit 510 through a structure of the leg unit 310 of the stirrer 300 surrounding the periphery of the vibration unit 510. Furthermore, the slurry is more effectively dispersed by being circulated near the vibration unit 510.

A distance between the inner peripheral surface of the leg unit 310 and the outer peripheral surface of the vibration unit 510 may be preferably about 5 to about 100 mm. Here, when the distance therebetween is about 5 mm or less, interference may occur between the leg unit 310 of the stirrer 300 and the vibration unit 510 of the ultrasonic generator 500 during assembly. In this case, it may be necessary to perform additional precision processing to prevent interference therebetween. Additionally, when the distance therebetween is about 100 mm or more, the slurry near the vibration unit 510 of the ultrasonic generator 500 may not be effectively circulated. Accordingly, the slurry may stagnate near the vibration unit 510, and the same may be exposed to ultrasonic waves of the vibration unit 510 for a long time, which may cause agglomeration of the slurry. Therefore, the distance between the inner peripheral surface of the leg unit 310 and the outer peripheral surface of the vibration unit 510 is preferably about 5 to about 100 mm.

In addition, a scraper 400 may be provided on the outer peripheral surface of the vibration unit 510 or the inner peripheral surface of the leg unit 310 of the present disclosure. Additionally, the scraper 400 may be made of a flexible material such as silicone.

Through this structure, the slurry may be circulated more effectively near the vibration unit 510, thereby not only preventing the slurry from stagnating near the vibration unit 510, but also preventing slurry agglomeration that occurs when the slurry is exposed to ultrasonic waves of the vibration unit 510 for a long time.

Meanwhile, a cooling jacket 700 of the present disclosure may be configured to reduce the temperature of the slurry flowing through the pipe. This structure may effectively dissipate heat generated when ultrasonic waves are transmitted to the slurry, thereby appropriately controlling the temperature of the slurry. In this manner, the slurry is reliably coated on a support or a current collector.

Additionally, the cooling jacket 700 may be formed on the outer peripheral surface of the pipe and extends along the pipe. Through this structure, the cooling jacket 700 does not interfere with transfer of the slurry flowing in the pipe, thereby preventing stagnation of the slurry. Accordingly, it is possible not only to prevent slurry agglomeration and generation of excessive heat that occur when the slurry is exposed to ultrasonic waves for a long time, but also to effectively cool the slurry in the pipe.

In addition, the flow direction of the slurry flowing through the pipe and the flow direction W of a refrigerant flowing through the cooling jacket 700 may be opposite each other. While being transferred in the pipe, the slurry may be dispersed by ultrasonic waves to generate heat, thereby having a higher temperature at a pipe outlet than at a pipe inlet. However, through the structure in which the flow direction of the slurry and the flow direction of the refrigerant flowing through the cooling jacket 700 are opposite each other, it is possible not only to effectively cool the slurry at the pipe outlet, which has a higher temperature than that of the slurry at the pipe inlet, but also to effectively maintain thermal balance of the slurry transferred in the pipe.

Meanwhile, the coating slurry supply device of the present disclosure further may include a controller (not shown) configured to control ultrasonic intensity and frequency of the ultrasonic generator 500, and a sensor 900 installed in the pipe and configured to sense information on the slurry, in which the information includes a change in physical properties including residence time in the pipe of the slurry, temperature of the slurry, or viscosity of the slurry. The controller (not shown) controls, based on the information including the residence time in the pipe, the temperature, or the viscosity of the slurry sensed by the sensor 900, ultrasonic intensity and frequency of the ultrasonic generator 500 according to a predetermined criterion.

Through this structure, ultrasonic waves may be transmitted to the slurry. Then, after the slurry is stirred, and physical properties of the slurry, such as viscosity and temperature of the slurry, are measured. Thereafter, a change in physical properties is sensed. According to the sensed physical properties of the slurry, ultrasonic intensity and frequency of the ultrasonic generator 500 are controlled. In this manner, viscosity and temperature of the slurry are appropriately controlled so as not to exceed a predetermined level.

FIG. 3 is a diagram showing another embodiment of the coating slurry supply device of the present disclosure. The coating slurry supply device of the present disclosure will be continuously described with reference to FIG. 3.

In another embodiment of the coating slurry supply device of the present disclosure, the pipe may be divided into an inlet pipe 110 and an outlet pipe 150. The inlet pipe 110 and the outlet pipe 150 may be connected to each other in a vertically offset state. Here, a part of the inlet pipe 110 and a part of the outlet pipe 150 are disposed so as to overlap each other. The stirrer 300 and the ultrasonic generator 500 are installed at a location where the inlet pipe 110 and the outlet pipe 150 are connected to each other.

In this case, the relative positions of the outlet pipe 150 and the inlet pipe 110 in the vertically offset state may be freely determined. More specifically, in another embodiment of the present disclosure, the offset outlet pipe 150 is disposed above the inlet pipe 110.

Through this structure, it is possible to secure a space in which the ultrasonic generator 500 and the stirrer 300 are installable in the pipe.

In addition, the stirrer 300 may include the leg unit 310 completely inserted into the pipe and rotated to stir a slurry. The leg unit 310 is built across the inlet pipe 110 and the outlet pipe 150. Further, the leg unit 310 is connected to an actuator 330 located outside the pipe through a rotation shaft 350. Additionally, the leg units 310 each having a rod shape or a bar shape are formed to extend in a state of being spaced apart from each other. Through this structure, a slurry stirring process is effectively performed by the leg unit 310, and the actuator 330 configured to rotate the leg unit 310 is installed outside the pipe, thereby enabling the slurry to be smoothly transferred through the pipe without interference between the slurry and the actuator 330. According to this structure, it is possible to prevent stagnation of the slurry and long-term exposure of the slurry to ultrasonic waves, thereby making it possible not only to prevent slurry agglomeration and excessive heat generation, but also to effectively maintain physical properties of the slurry suitable for coating on a current collector or a support. Accordingly, an additive containing a conductive material in the slurry may be effectively mixed.

In addition, in the ultrasonic generator 500 of another embodiment of the present disclosure, the inlet pipe 110 and the outlet pipe 150 may be connected to each other in the vertically offset state so as to partially overlap each other. Here, the ultrasonic generator 500 is installed at a location where the inlet pipe and the outlet pipe are connected to each other, and the vibration unit 510 having a rod shape or a bar shape is installed in a state of being completely inserted into the pipe. Through this structure, transfer S of the slurry is smoothly performed through the pipe without stagnating in the vibration unit 510.

The slurry may not be affected by ultrasonic waves for a long time, thereby preventing a rapid increase in viscosity of the slurry. Accordingly, the additive containing the conductive material in the slurry is effectively dispersed, and an increase in viscosity and temperature of the slurry may be effectively prevented.

Further, the scraper 400 may be provided on the outer peripheral surface of the leg unit 310 of the stirrer 300 adjacent to the ultrasonic generator 500. Here, the scraper 400 scrapes the slurry remaining in a space defined between the ultrasonic generator 500 and the outer peripheral surface of the leg unit 310. Through this structure, stagnation of the slurry near the ultrasonic generator 500 is prevented, and the dispersed slurry is smoothly transferred. In this manner, the slurry is effectively circulated so as to prevent slurry agglomeration and excessive heat generation.

In addition, the scraper 400 may be provided on the outer peripheral surface of the leg unit 310 of the stirrer 300 adjacent to the ultrasonic generator 500. Here, the scraper 400 scrapes the slurry remaining in a space defined between the inner peripheral surface of the vibration unit 510 of the ultrasonic generator 500 and the outer peripheral surface of the leg unit 310. Through this structure, stagnation of the slurry near the vibration unit 510 is prevented, and the dispersed slurry is smoothly transferred. In this manner, the slurry is effectively circulated so as to prevent slurry agglomeration and excessive heat generation.

FIG. 4 is a diagram showing still another embodiment of the coating slurry supply device of the present disclosure. The coating slurry supply device of the present disclosure will be continuously described with reference to FIG. 4.

The ultrasonic generator 500 of still another embodiment of the coating slurry supply device of the present disclosure may be disposed on the inner surface of the pipe at a location where the inlet pipe and the outlet pipe are connected to each other. The ultrasonic generator has a flat shape.

The ultrasonic generator may have a portion configured to transmit vibration to the slurry and completely inserted into the pipe, thereby making it possible to prevent slurry agglomeration and excessive heat generation. Here, when a structure does not cause stagnation of a slurry, an additive containing a conductive material in the slurry may be dispersed regardless of the location and shape of the ultrasonic generator.

Further, the scraper 400 may be provided on the outer peripheral surface of the leg unit 310 of the stirrer 300 adjacent to the ultrasonic generator 500. Here, the scraper 400 scrapes the slurry remaining in a space defined between the ultrasonic generator 500 and the outer peripheral surface of the leg unit 310. Through this structure, stagnation of the slurry near the ultrasonic generator 500 is prevented, and the dispersed slurry is smoothly transferred. In this manner, the slurry is effectively circulated so as to prevent slurry agglomeration and excessive heat generation.

Table 1 is a table showing a comparison between black-and-white degrees of the slurry. The effect of the coating slurry supply device of the present disclosure will be described in detail with reference to table 1.

Table 1 shows a comparison between a black-and-white degree of a slurry mixed only through stirring without ultrasonic dispersion and a black-and-white degree of a slurry mixed through stirring and ultrasonically dispersed using the coating slurry supply device of the present disclosure. In this case, as the black-and-white degree of the slurry is higher, an additive containing a conductive material in the slurry is uniformly dispersed. Here, as the black-and-white degree is higher, the color is closer to black, and as the black-and-white degree is lower, the color is closer to white.

TABLE 1
Comparison between black-and-white degrees of slurry

| | Before ultrasonic | After ultrasonic |
|---|---|---|
| | dispersion | dispersion |
| Black-and-white degree | 75.12 | 80.27 |

Table 1 shows that the black-and-white degree of the slurry mixed through stirring and ultrasonically dispersed using the coating slurry supply device of the present disclosure is higher than the black-and-white degree of the slurry mixed only through stirring without ultrasonic dispersion.

Through this result, it is found out that the coating slurry supply device of the present disclosure effectively disperses the additive containing the conductive material in the slurry.

As is apparent from the above description, the present disclosure may provide a coating slurry supply device including an ultrasonic generator and a stirrer installed in a pipe configured to allow a slurry to be transferred therethrough. While the slurry is transferred through the pipe, a slurry additive containing a conductive material is dispersed and stirred. Through this structure, while being transferred through the pipe, the slurry does not stagnate in a specific section, thereby making it possible not only to prevent slurry agglomeration caused by long-term mixing or dispersion, but also to minimize a change in physical properties of the slurry and maximize dispersion of the additive containing the conductive material.

Additionally, the slurry, the temperature of which increases due to heat generated during mixing or dispersion, may be cooled through a cooling jacket, thereby appropriately adjusting the temperature so as to coat the slurry on a current collector or a support.

Although the preferred embodiments of the present disclosure have been disclosed for illustrative purposes, those skilled in the art will appreciate that various modifications, additions, and substitutions are possible, without departing from the scope and spirit of the disclosure as disclosed in the accompanying claims.

What is claimed is:

1. A coating slurry supply device comprising:
a pipe configured to allow a slurry containing an additive to flow therethrough;
a conveyance mechanism configured to flow the slurry through the pipe;
a stirrer installed in the pipe and configured to stir the slurry flowing through the pipe; and
an ultrasonic generator installed in the pipe and configured to disperse the additive contained in the slurry by applying ultrasonic waves to the slurry flowing through the pipe.

2. The coating slurry supply device according to claim 1, wherein the ultrasonic generator comprises a vibration unit configured to transmit vibration to the slurry flowing through the pipe to disperse the additive contained in the slurry, and wherein the vibration unit is completely inserted into the pipe.

3. The coating slurry supply device according to claim 1, wherein the ultrasonic generator comprises a driving unit configured to operate the vibration unit, and wherein the driving unit is disposed outside the pipe.

4. The coating slurry supply device according to claim 1, wherein the pipe is formed to extend with a constant inner diameter thereof, and wherein the inner diameter remains the same at a location where the stirrer and the ultrasonic generator are installed.

5. The coating slurry supply device according to claim 2, wherein the stirrer comprises a leg unit rotated in a state of being completely inserted into the pipe and configured to stir the slurry.

6. The coating slurry supply device according to claim 5, wherein the leg unit of the stirrer surrounds the vibration unit.

7. The coating slurry supply device according to claim 6, wherein the leg unit comprises an inner circumferential surface configured to surround the vibration unit, being spaced apart from an outer circumferential surface of the vibration unit by a predetermined distance.

8. The coating slurry supply device according to claim 7, wherein the predetermined distance is about 5 to about 100 mm.

9. The coating slurry supply device according to claim 7, wherein the vibration unit or the leg unit comprises a scraper provided on the outer circumferential surface thereof or the inner circumferential surface thereof, and wherein the scraper is configured to scrape the slurry remaining in a space defined between the outer circumferential surface of the vibration unit and the inner circumferential surface of the leg unit.

10. The coating slurry supply device according to claim 1, wherein the pipe is divided into an inlet pipe and an outlet pipe, wherein the inlet pipe and the outlet pipe are connected to each other in a vertically offset state so as to partially overlap each other, and wherein the stirrer and the ultrasonic generator are installed at a location where the inlet pipe and the outlet pipe are connected to each other.

11. The coating slurry supply device according to claim 10, wherein the outlet pipe is disposed above the inlet pipe.

12. The coating slurry supply device according to claim 10, wherein the stirrer comprises a leg unit rotated in a state of being completely inserted into the pipe and configured to stir the slurry, wherein the leg unit is built across the inlet pipe and the outlet pipe, and wherein the leg unit is connected to an actuator located outside the pipe through a rotation shaft.

13. The coating slurry supply device according to claim 10, wherein the ultrasonic generator is disposed on an inner side of the pipe located at the location where the inlet pipe and the outlet pipe are connected to each other.

14. The coating slurry supply device according to claim 10, wherein the leg unit of the stirrer adjacent to the ultrasonic generator comprises a scraper provided on an outer circumferential surface thereof, and wherein the scraper is configured to scrape the slurry remaining in a space defined between the ultrasonic generator and the outer circumferential surface of the leg unit.

15. The coating slurry supply device according to claim 1, further comprising a cooling jacket configured to reduce temperature of the slurry flowing through the pipe.

16. The coating slurry supply device according to claim 15, wherein the cooling jacket is formed on an outer circumferential surface of the pipe and extends along the pipe.

17. The coating slurry supply device according to claim 15, wherein the slurry flowing through the pipe has a flow direction opposite a flow direction of a refrigerant flowing through the cooling jacket.

18. The coating slurry supply device according to claim 1, further comprising:
a sensor installed in the pipe and configured to sense information on the slurry; and
a controller configured to control the ultrasonic generator based on the information, according to a predetermined criterion.

19. The coating slurry supply device according to claim 18, wherein the information comprises a change in physical properties comprising residence time in the pipe of the slurry, temperature of the slurry, or viscosity of the slurry.

20. The coating slurry supply device according to claim 18, wherein the controller is configured to control ultrasonic intensity or frequency of the ultrasonic generator based on the information.
